(19) United States
(12) Patent Application Publication
(10) Pub. No.: US 2006/0229932 A1
(43) Pub. Date: Oct. 12, 2006

(54) Intelligent sales and marketing recommendation system

(75) Inventors: Stephen A. Zollo, Ocean City, NJ (US); Steven A. Shaya, Highlands, NJ (US); Spyros Stavrakas, Richboro, PA (US)

Correspondence Address: WOODCOCK WASHBURN LLP, ONE LIBERTY PLACE, 46TH FLOOR, PHILADELPHIA, PA, 19103, US

(73) Assignee: Johnson & Johnson Services, Inc., New Brunswick, NJ (US)

(21) Appl. No.: 11/370,526

(22) Filed: Mar. 7, 2006

Related U.S. Application Data
(60) Provisional application No. 60/668,886, filed on Apr. 6, 2005.

(51) Int. Cl. G07G 1/00

(52) U.S. Cl. 705/10

(57) ABSTRACT

Systems and methods for generating intelligent promotional recommendations and reports are disclosed. The systems and methods utilize longitudinal patient or physician level data and longitudinal data regarding sales and marketing techniques and approaches employed to train intelligent processing elements such as collaborative filters, neural networks, and combinations thereof. Intelligent recommendations are made and data is compiled regarding the recommendations implemented and physician and patient activities after the recommendations are implemented. Ongoing data is used as feedback to re-train the processing elements and refine the sales and marketing techniques and approaches employed.

### CROSS REFERENCE TO RELATED APPLICATIONS

This application claims the benefit of U.S. Provisional Application Serial No. 60/668,886, filed Apr. 6, 2005, the contents and disclosure of which is incorporated herein by reference in its entirety.

The subject matter disclosed and claimed in this Application is related to the subject matter of U.S. patent application Ser. No. 09/981,516, filed on Oct. 17, 2001, the contents and disclosure of which is incorporated herein by reference in its entirety.

### FIELD OF THE INVENTION

The inventions relate to the field of sales and marketing analysis and prediction.

### BACKGROUND OF THE INVENTION

Companies spend billions of dollars each year to promote products using a wide variety of techniques and approaches. In the case of pharmaceutical and medical products, these promotional techniques and approaches often involve sales or marketing representatives providing physicians with information about their products in an effort to have the physicians write prescriptions for and/or recommend the use of their products. Other techniques that are used to the hopes of influencing physicians include face-to-face discussions of product utility and applicability, providing samples of products, providing promotional materials about products, providing tickets to sporting and cultural events, and the like. Since the rise of the Internet and managed care entities, promotional techniques and approaches for pharmaceutical and medical products also have included providing product information on publicly and privately accessible websites, in direct-to- consumer advertising (e.g., radio, television and other mass media advertising), and by direct marketing and sales to managed care and other benefits providers or payers who influence or control formulary positions (i.e., lists of drugs covered by a particular plan, either at full or something less than full reimbursement rates).

With the increasing use of ever-more sophisticated technology in healthcare and related areas, richer and more granular data on activities relating to healthcare (e.g., patient and physician activity) have become available from a variety of sources in a variety of forms. This data offers the potential, if compiled, analyzed, and utilized appropriately, to more accurately understand patient and physician behavior; and for companies to achieve a better return on investment by predicting, employing, and refining more effective sales and marketing techniques and approaches for their products. In general, this new data falls into the following commercially available classes or types, portions of which may overlap one another in varying degrees: longitudinal prescription data, longitudinal patient data, pharmacy benefit manager data, switch-sourced data, and integrated medical and pharmacy chains data. Examples of companies from which such data may be obtained include: Dendrite International, Inc., Bedford, New Jersey (www.dendrite.com); Verispan, Yardley, Pennsylvania (www.verispan.com); IMS Health, Inc., Fairfield, Connecticut (www.imshealth.com); and NDCHealth Corp., Atlanta, Georgia (www.ndchealth.com), among others.

Longitudinal prescription data typically is derived directly from prescription transaction information provided by pharmacies themselves or through data vendors, and may contain some or all of the information associated with a prescription (e.g., unique but anonymous patient identifier, patient age, patient gender, prescribing physician identifier, drug code, dispensed date, dispensed quantity, number of therapy days dispensed, refill number, number of refills allowed, dispensed as written indicator). If a prescription may be covered by a customer's insurance, then a pharmacy benefits manager often processes a claim for coverage before submitting the claim to the appropriate health insurance company or benefits provider on the customer's behalf. This is the source of pharmacy benefit manager data, which, in addition to longitudinal prescription data, typically includes data relating to the claims process (e.g., insurance or benefits provider, coverage plan or type, etc.). When information like that noted above for longitudinal prescription data also includes diagnosis codes (e.g., International Disease Classification or ICD-9 codes), then the data typically is referred to as longitudinal patient data (LPD). In order for data to be considered “longitudinal,” it must include information that links it to a discrete date/time or an equivalent thereof.

Switch-sourced and integrated medical and pharmacy claims data typically includes some medical data in addition to prescription data. The medical information in these data sources is often captured from insurance claims and may include any or all of the following: diagnosis codes (e.g., comorobidities, adverse events, ICD-9 codes), patient demographics (e.g., age, gender, race, etc.), medical provider specialty, dates (service, prescription filled, etc.), benefits enrollment information, medical services information (e.g., Current Procedural Terminology or CPT codes, hospitalizations, emergency room visits, office visits, home care, diagnostic results, laboratory results, procedures performed, Healthcare Common Procedure Coding System information or HCPCS codes, health plan type, charges, payments, etc.). Switch-sourced data derives its name from the fact that it is typically captured by the switches (combination of software and hardware) through which electronically processed pharmacy and medical claims are often routed to health insurers, benefits providers, and the like.

Yet another form of patient level data that is available, albeit on a very limited basis at this time, is electronic medical record or EMR data. Medical records contain data that can be used for many purposes beyond individual patient care if they are reasonably complete and available for a relevant segment of persons (e.g., patients, physicians, healthcare organization). A medical record is the information compiled by a healthcare professional(s) or organization(s) that relates to a patient's health and medical care. A medical record may contain some or all of the following types of information: a patient's personal details (e.g., name, address, date of birth, etc.), a summary of the patient's medical history, and documentation about each medical event for the patient, including symptoms, diagnosis, treatment and outcome. Documents and correspondence relating to a patient's care may be included as well, and other forms of information are likely to be included in the future too (e.g., images, audio files, video files, etc.). Traditionally, each healthcare provider involved in a patient's care has kept an independent record in paper form. Thus, one individual may have a multitude of independent medical records, all of which may be in paper form. There is, however, a serious push in the field of healthcare to use EMR rather than paper records, and to integrate individual patient's medical records into a single EMR that can be shared by all appropriate persons and entities involved in that patient's care. As this occurs, EMNR data will provide yet another robust and highly granular source of information which can be used to achieve better return on investment by pharmaceutical and medical products companies if utilized appropriately.

As those ordinarily skilled in the art will appreciate, the types of data noted above can be analyzed in many cases to determine approximately how many prescriptions for a specific drug are being written by individual physicians and/or filled by individual patients. This information can give a rough indicator of whether a company's sales and marketing campaign for a drug or product is relatively effective or ineffective. However, if the campaign is relatively ineffective, as evinced for example by low prescription generation by individual or relevant groups of physicians, low initial fill rates of prescriptions written by a physician or physicians, and/or low refill rates of prescriptions, the types of data noted above, by themselves, cannot indicate what if anything may have been wrong with a sales and marketing campaign or how the campaign could be made more effective (i.e., more prescriptions written, more prescriptions filled, and more prescriptions refilled). Accordingly, something more than simply having access to robust, granular patient level data is needed to accurately and intelligently increase return on product investment.

Some pharmaceutical and medical product consulting firms, database vendors and pharmaceutical companies themselves have experimented with a variety of techniques for using these new sources of data in an effort to increase the sales of pharmaceuticals by increasing the number of prescriptions written for those pharmaceuticals. To date, however, none of these efforts have borne much fruit in providing meaningful, real-world insight about the effectiveness, or ineffectiveness, of various techniques and approaches to the selling and marketing of pharmaceutical and medical products. Nor have these efforts provided any meaningful, real-world insight about how to increase return on product investment by accurately predicting the effectiveness of various sales and marketing techniques and approaches in various settings or with particular physicians or groups of physicians. Applicant's inventions address this problem and others.

### SUMMARY OF THE INVENTION

Systems for and methods of generating intelligent sales and/or marketing recommendations are disclosed. While the inventions are not limited to the sales and marketing of pharmaceutical and medical products, that is the context in which the inventions will be shown and described. In one embodiment, recommendations are generated that provide the highest probability of increasing sales of a product by increasing the likelihood that a prescription will be written by a particular physician. In other embodiments, recommendations are generated that provide the highest probability that prescriptions will be written by a particular physician, that the prescriptions will be filled by the relevant population of patients that physician typically sees, and/or that the prescriptions will be refilled by such patients. Recommendations also may be generated that provide the highest probability of a prescription being written by particular groups or types of physicians, that the relevant populations of patients typically seen by the physicians will fill the prescriptions, and/or that the relevant populations of patients will refill the prescriptions. Recommendations also may be generated that have a range of probabilities so that managers or others can decide, based on the circumstances at the time, whether certain sales and marketing techniques should be pursued even though others have a higher probability of being more effective (e.g., due to budget concerns, being late in the product's life cycle, the difference in predicted returns being minimal, etc.). The inventions also may be used to generate a wide variety of reports based on the analyses for recommendations that can be used by management or others for decision-making with respect to products and sales and marketing approaches and campaigns, among a variety of things.

Preferred embodiments of the inventions utilize intelligent recommendation systems like those shown and described in co-owned U.S. Patent Application Publication No. US2002/0161664 in conjunction with longitudinal data regarding patients, physicians, and sales and marketing approaches and techniques for the product or products under consideration. Longitudinal data for a product or products considered similar to the product or products under consideration also may be used. Data about individual sales and/or marketing representatives (or groups of sales and/or marketing representatives) may be used in conjunction with the foregoing data as well to obtain recommendations that account for the individual sales or marketing representative's (or group's) past and/or projected performance/effectiveness with a particular physician, group(s) of physicians, or relevant decision-maker(s) to be approached or the subject of a technique or campaign. Particular embodiments of the inventions also provide the capability to input a request for intelligent recommendations via a personal data assistant (PDA) or similar device (e.g., a BLACKBERRY, a POCKET PC, a TREO).

Historical longitudinal and/or subjective data is used to initially train the processing element(s) in an intelligent recommendation engine, which typically includes a neural network or collaborative filter. After a system is initially trained, it is placed in operation and intelligent recommendations and/or reports may be generated in response to requests. Where the engine employs a collaborative filter, the engine utilizes various algorithms to determine relevant neighborhoods of longitudinal data for the product and target (e.g., individual physician to be approached) addressed by a request, and the longitudinal data is analyzed by processing element(s) in the engine to create intelligent recommendations. Longitudinal data compiled thereafter is used as objective feedback regarding physician and/or patient responses to sales and/or marketing activities. Longitudinal data regarding the specific sales and/or marketing activities employed during the relevant period of time is also provided to the system as feedback, although one could have the system assume that the recommendations previously generated were followed. In embodiments where data regarding individual or groups of sales and marketing personnel are incorporated in the system, longitudinal feedback about the specific personnel or groups of personnel who engaged in the sales or marketing activity would be provided to the system as well. The system uses the feedback received to re-train the algorithms contained in the intelligence/processing element(s) of the recommendation engine, thereby allowing future recommendations to be continually refined based on real-world data regarding responses to sales and marketing activities.

In addition to the foregoing, embodiments of the inventions may be set up to utilize longitudinal data regarding physicians' and/or patients' impressions of the relevant sales and/or marketing techniques and approaches, physicians' and/or patients' impressions of products, physicians' impressions of how they presented or described products or companies to patients, patients' impressions of how products or companies were presented or described to them, and/or patients' impressions of products or companies. Subjective longitudinal data such as this is, although difficult to compile, is believed to provide an additional dimension of data that would be important in accurately predicting prescription filling and refilling probabilities. For example, it is believed that the way in which a product is presented or described to a patient, and the way that a patient perceives a physician's presentation or description of a product will measurably impact whether that patient ultimately fills a prescription written by the physician or uses a product recommended by a physician. Similar logic applies to the other data noted immediately above. Incorporating longitudinal data capturing this subjective information into the intelligent recommendation system will provide even more accurate recommendations.

As noted before, the inventions are not limited to the sales and/or marketing of pharmaceutical or medical products. Rather, the inventions may be employed in any context where longitudinal data regarding buyers' and sellers' and/or marketers' activities may be obtained or compiled.

### BRIEF DESCRIPTION OF THE DRAWINGS

The foregoing summary, as well as the following detailed description of exemplary embodiments, is better understood when read in conjunction with the appended drawings. For the purpose of illustrating embodiments of the invention, there are shown in the drawings exemplary constructions of the invention; however, the inventions are not limited to the specific embodiments disclosed and described herein. In the drawings:

FIG. 1 depicts exemplary embodiments of an intelligent recommendation system;

FIG. 2 depicts the recommendation functions of an exemplary intelligent recommendation system;

FIG. 3 depicts a flow diagram of exemplary portions of a method for generating intelligent recommendations; and

FIG. 4 depicts a flow diagram of exemplary portions of a method for re-training the recommendation engine in an exemplary intelligent recommendation system.

### DETAILED DESCRIPTION OF ILLUSTRATIVE EMBODIMENTS

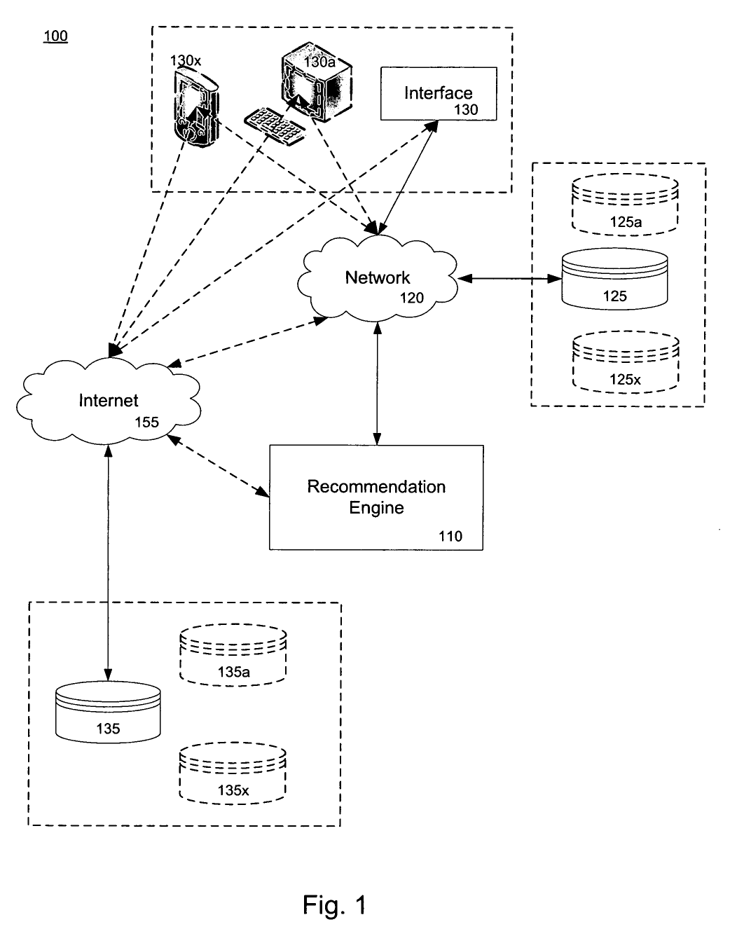

FIG. 1 depicts exemplary embodiments of an intelligent recommendation system 100 in accordance with the inventions. A recommendation engine 110, a database 125, and an interface 130 are all operatively connected to a computer network 120 via appropriate means given the specific hardware (not shown). Interface 130 may comprise a personal computer 130a, a mainframe computer terminal (not shown), a personal digital assistant (PDA) 130b, or similar device, whatever is compatible with or appropriate for the particular computer network 120 utilized in system 100. There also may be a multiplicity of terminals 130a, 130x. Requests also may be relayed from a user in the field to a central or district resource for entry in interface 130 on the user's behalf. Database 125 also may comprise a multiplicity of databases 125a, 125x.

Database(s) 125 contains the longitudinal and other data utilized by the system 100 to generate intelligent recommendations in response to requests. Those ordinarily skilled in the art will recognize that database(s) 125 need not be a dedicated database but could in fact reside within an element or elements of network 120 that perform other functions, or even within interface 130 if it contains suitable storage and processing capabilities (e.g., a MICROSOFT ACCESS database residing on a personal computer). System 100 also may be configured to directly access longitudinal data contained in third-party databases. In this embodiment of the invention, system 100 is operatively connected to third-party database 135 via the Internet 155, an intranet (not shown), a dedicated network connection (not shown), or some other suitable means of communication. As with database 125, third-party database 135 may comprise a multiplicity of databases 135a, 135x.

After the processing elements in recommendation engine 110 are initially trained and system 100 placed into operation, a user makes a request for a recommendation(s) or report(s) by way of interface 130. Depending on the implementation, information such as the particular physician or group of physicians to be considered and the particular person or type of person to implement the recommendation(s) are provided in the request, in addition to the particular product or products for which recommendations are to be generated. After the recommendation engine receives and processes the request, a recommendation(s) is returned to the user via interface 130. Recommendations also may be sent to others if desired.

Taking the case of a request for intelligent recommendations as to how a particular physician should be approached by a sales representative regarding product X, recommendations could include things such as: making direct contact with the physician, including type of contact, amount of time to be spent with decision-maker (e.g., maximum, minimum, range of time), and/or the most advantageous times of day to approach the decision-maker; providing product samples; quantities of product samples to be provided; providing product information, providing drug trial information, offering attendance at a medical meeting, offering attendance at education symposiums, and the like. Types of direct contact with a decision-maker could include activities such as telephone conversations, face-to-face discussion of technical materials, discussion of patient treatments, invitations to participate in clinical trials, lunch, dinner, a game of golf, and so on. Tickets to sports or cultural and other events or activities could be recommended as well. Those skilled in the art will understand the multitude of possible sales and/or marketing techniques and approaches that can be incorporated into the system and be considered as potential recommendations to be made based on the relevant longitudinal data. Recommendations for implementations addressing groups of physicians or other relevant decision-makers would be similar and include the techniques or approaches relevant for them. Recommendations or reports could include generating preference or predicted performance scores for each type of possible sales or marketing technique or approach tracked by the system for a particular physician(s) or decision-maker(s), or could include generating a top N list of such techniques or approaches (e.g., top 5, top 10, etc.) for such person(s). In addition to the generation of specific recommendations, the present invention also may generate related analytical reports and assist in the analysis of targeting issues. Such reports can rank physicians or decision-makers in terms of the relationship between such items as samples and the subsequent prescribing history and the like. Thus, any single promotional technique can be evaluated not only on a single physician or decision-maker, but also on a group of physicians or decision-makers to assist in the evaluation of the value of the sales or marketing technique. The reports could even be focused on a particular indication area, such as a specific drug area or a group of drugs in a single area such as inflammation control pharmaceuticals, arthritis medications, and the like. Indication areas may also include a single group of physicians operating in a single geographic area. One having ordinary skill in the art will recognize that any one or group of many characterizing variables may be selected as an indication and processed data may be organized to expose the data relating to those variables.

The distribution of recommendations or reports generated by system 100 within a company is up to the company or entity implementing the system. For example, a pharmaceutical company could use system 100 to support its market research and sales operations at all levels of the organization, or recommendations and reports could be limited solely to the persons submitting requests. In addition, variously configured requests could be used to expand, complement, or replace sales and marketing tools currently in use. In preferred embodiments, system 100 is implemented so that recommendations for sales and marketing techniques and approaches to be employed increase or optimize the return on investment for a particular product(s) at an organization level.

As with systems and methods disclosed and described in co-owned U.S. Patent Application Publication No. US2002/0161664 A1, recommendation engine 110 may employ a neural network(s), a collaborative filter(s), a content-based filter(s), and/or combinations thereof. The implementations and operations of these various data analysis approaches are explained in U.S. Patent Application Publication No. US2002/0161664 A1 and will not be repeated at length here. To aid in transferring the teachings in U.S. Patent Application Publication No. US2002/0161664 A1 to the context of the inventions here, some of the various terminology employed in U.S. Patent Application Publication No. US2002/0161664 A1 correlate to the inventions here as follows: “consumers” correspond to physicians or decision-makers herein; “targets” correspond to the products under consideration herein; “products” correspond to the sales or marketing techniques under consideration herein; “concerns” correspond to the goal(s) of the inventions herein (e.g., increased return on investment (overall, for sales expenditures, for marketing expenditures, for product sampling, and the like), increased number of prescriptions written, increased number of prescriptions initially filled, increased number of prescriptions refilled, inclusion within formulary positions, and the like); and “importance levels” and/or “severity levels” correspond to ratings that could be made by users of the systems in a request for recommendations or reports or could be set by management to ensure that certain concerns always have priority over others. “Aesthetic choice information,” unlike in the systems and methods shown and described in U.S. Patent Application Publication No. US2002/0161664 A1 where it is an input received from users of the systems and methods, would be determined by the recommendation engine herein through analysis of longitudinal data as a potentially relevant consideration(s) for generating recommendations or reports (e.g., a relevant dimension in the neighborhood definition function in a collaborative filter, a relevant relationship that is modeled by the neural network, and the like).

As explained in more detail in U.S. Patent Application Publication No. US2002/0161664 A1, collaborative filters generally have three main elements: data representation, neighborhood formation function, and recommendation generation functions. In embodiments of the inventions herein employing a collaborative filter(s), longitudinal data relevant to a particular product(s) is represented in the database(s), relevant neighborhoods of suitably similar physician(s) or decision-maker(s) included in the longitudinal data are created, and recommendations or reports are generated based on the data contained in a request in view of the neighborhoods formed. Whether a physician or decision-maker and product of interest is considered suitably similar by the intelligence in the recommendation engine will depend on a variety of factors, including the level of accuracy specified by a user or programmed into the system. For example, early in the operation of the system one might expect that in order to get suitable accuracy neighborhood sizes would be have to be relatively large and possibly include data for products similar to the particular product of interest whereas later, after enough longitudinal data has been compiled for the particular product of interest over a large enough population of physicians, decision-makers, or the like, the neighborhood sizes might be significantly smaller and include no data from products other than the particular product of interest. Also as explained in U.S. Patent Application Publication No. US2002/0161664 A1, neural networks model non-linear relationships between independent and dependent variables through the use of an equation or equations incorporating functions called connection weights. In this case, the inputs would be longitudinal data regarding the sales and marketing techniques and approaches employed and the targets of those techniques and approaches, and the outputs would be how the targets responded to the techniques and approaches and/or the how the concerns noted above changed in response to the techniques and approaches employed. In view of the terminology correlation above, the other information contained herein, and U.S. Patent Application Publication No. US2002/0161664 A1, one ordinarily skilled in the art will be able to readily construct a recommendation engine for use in the intelligent sales and marketing recommendation systems of the present inventions.

In addition to the variables noted elsewhere, physician characterizations, patient characterizations, physician-sales representative relationship characterizations, product sampling characterizations, product prescription characterizations, and formulary characterizations all may influence the effectiveness of sales and marketing techniques and approaches to be employed in the systems and methods of the present inventions. For example, a system might identify that even though a particular physician has been given various quantities of samples over time, the particular physician's prescription writing activity has not been effected in any meaningful way by the provision of those samples and not recommend sampling as an effective approach for that physician. A system could also identify that the more samples given to a particular physician over time, the fewer the number of prescriptions written by the physician and recommend providing fewer samples or no samples at all as a means of either increasing the number of prescriptions written by the physician and/or minimizing the losses due to oversampling of the particular physician regardless of whether any increase in the number of prescriptions are subsequently written by the particular physician. Similarly, a system could use persistency information in the longitudinal data to identify prescribers with lower than average patient persistency and recommend giving such prescribers more marketing materials for patients that encourage them and explain the benefits of staying on their medication and/or spending time encouraging such prescribers to discuss persistency with their patients more often or in a different way.

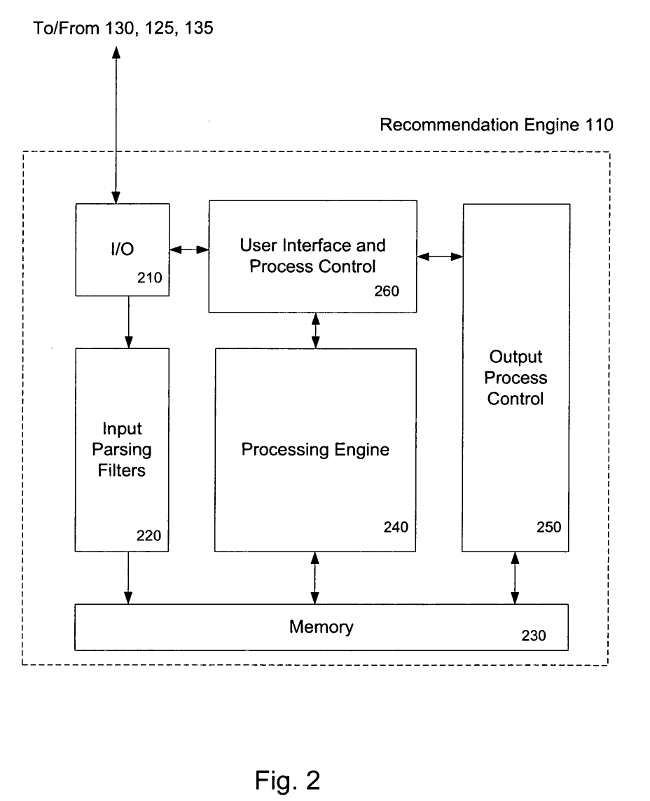

FIG. 2 depicts an embodiment of recommendation engine 110 as described with reference to FIG. 1 in functional element form. An Input/Output 210 function is used to send and receive information and instructions to and from the remainder of the system, including any connections to third-party databases, the Internet, or the like. Instructions, requests, or by a user are received from interface 130 and routed to the user interface and process control 260. Where a request for recommendations for a particular physician or decision-maker is received, the user interface and process control 260 would generate commands to access the databases 125 and/or 135 and issue those commands via I/O 210. Upon receiving data from a database 125 and/or 135 via I/O block 210, the data is parsed using input filters that identify and separate the data into various streams based on relevant content and stored in memory 230 so that they may be readily accessible to the processing engine 240 and the output process control 250. Process control 260 exercises the processing engine 240 to access the data streams from memory 230 and create the recommendations using the intelligence contained therein (e.g., collaborative filter or neural network). Once recommendations are generated, the processing engine may pass the results to memory 230 so that the output process control 250 can access, assemble and format the results according to the user request. In an alternate embodiment, the recommendations from the processing engine may be delivered directly to the output process control function instead of being stored in memory 230. In either event, once the recommendations are formatted by the output process control, they are passed to the I/O block 210 via process control 260 and sent to a user interface 130.

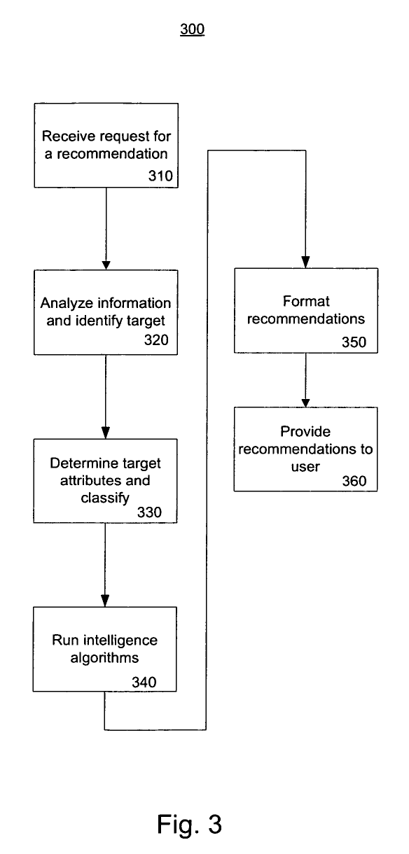

FIG. 3 depicts a flow diagram of exemplary portions of a method of generating intelligent recommendations. The method 300 provides recommended sales or marketing techniques or approaches in response to a request received from a user. Method 300 starts with receipt of a request for a recommendation (step 310) for a particular product(s) and particular physician(s) or decision-maker(s). Upon receipt of the request, the information contained therein is analyzed to determine the particular physician(s) or decision-maker(s) and product(s) of interest (step 320). After determining the particular physician(s) or decision-maker(s) and product(s) of interest, the process determines the attributes of the particular physician(s) or decision-maker(s) and classifies the particular physician(s) or decision-maker(s) relative to the entire population of physicians or decision-makers for the particular product(s) (step 330). If the process is employing a collaborative filter as the sole or initial processing technique, classifying the physician(s) or decision-maker(s) means determining within which neighborhood or neighborhoods the physician or decision-maker falls for the product(s) of interest and accuracy specified or requested. For example, the process may determine in step 320 that the physician of interest has provider identification number 0123. In step 330 the process would then access detailed longitudinal and other information about provider number 0123 (e.g., biographical data, geographical data, past prescribing behavior data for the particular product(s), educational data, etc.) and, in view of the accessed information, place the physician in neighborhoods X and Z for the particular product(s). Neighborhoods X and Z would have been formed at the time the collaborative filter was initially trained or subsequently retrained in view of longitudinal feedback. Similar activities will be performed if the process is employing a neural network as the sole or initial processing technique, except that the classifying would be in terms of which neural network equation to apply in view of the detailed information about the particular physician rather than which neighborhoods are applicable.

Once the physician(s) or decision-maker(s) of interest are classified, the process runs the appropriate algorithms in view of the classification to generate a recommended sales or marketing technique or approach (step 340). Multiple, ranked sales or marketing techniques or approaches could be recommended as well (e.g., a top N list), as well as probability predictions (e.g., 90% chance of increasing number of prescriptions written by X%, 20% chance of decreasing sampling expenses with an 80% of maintaining same number of prescriptions written, etc.). The recommendation(s) are then formatted in way that they may be viewed by the user making the request (step 350). Finally, the formatted recommendations are provided to the user who made the request (step 360). Although not shown, in preferred embodiments the recommendation(s) also will be stored in memory for use as potential feedback to retrain the system or for other business purposes.

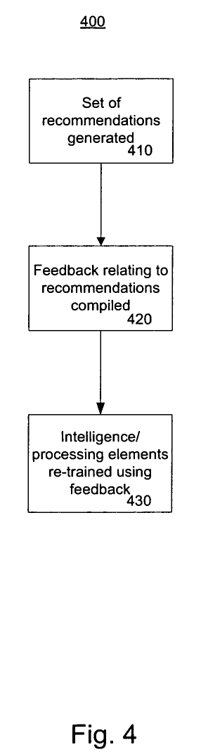

FIG. 4 depicts a flow diagram of exemplary portions of a method 400 for re-training the recommendation engine in an exemplary intelligent recommendation system. First, a statistically relevant number of sales or marketing recommendations are generated by the system for a particular product (step 410). Second, longitudinal data relating to the sales and marketing techniques and approaches actually implemented after the recommendations were made, and longitudinal data relating to relevant patient and/or physician activity (i.e., consumer) with respect to the product after the recommendations were made are compiled (step 420). This data comprises feedback, could be stored in databases such as 125 and/or 135 in system 100, and could comprise any of the longitudinal and other data types noted above. In addition, a “consumer” could include any target for which a particular system can address. Finally, the feedback is used to re-train the intelligence/processing element(s) utilized to make the recommendations (step 430). The particulars of using feedback to re-train collaborative filters, neural networks, and the like are discussed in more detail in U.S. Patent Application Publication No. US2002/0161664.

Though aspects of the inventions have been described in connection with the exemplary embodiments depicted in the Figures, those having ordinary skill in the art will recognize that the inventions are not limited to these exemplary embodiments and that many other embodiments of the inventions are possible.

What is claimed:

1. A system for generating intelligent promotional recommendations for a product, comprising:
a) a database containing longitudinal data related to non-promotional activity with respect to a product and longitudinal data related to one of sales activities for the product and marketing activities for the product;
b) a recommendation engine, operatively connected to the database, comprising means for generating, in response to a request relating to a target, one of an intelligent sales recommendation and an intelligent marketing recommendation; and
c) a user interface, operatively connected to the recommendation engine, for generating the request.

2. The system of claim 1 wherein the means for generating intelligent recommendations comprises one of a collaborative filter, a neural network, and a content-based filter.

3. The system of claim 1 wherein the product comprises a pharmaceutical product, and the longitudinal data related to non-promotional activity with respect to the product comprises one of longitudinal patient data and electronic medical record data.

4. The system of claim 3 wherein the target comprises one of a physician, a group of physicians, a managed care provider, and a benefits provider.

5. The system of claim 4 wherein the recommendation generated by the means for generating increases one of a likelihood that a prescription will be written for the product by the target, a likelihood that a prescription written for the product by the target will be filled by a patient, and a likelihood that a prescription written for the product by the target will be refilled by a patient.

6. The system of claim 1 further comprising means for re-training the recommendation engine with longitudinal feedback regarding ongoing non-promotional activities with respect to the product and ongoing sales and marketing activities for the product.

7. The system of claim 3 wherein the user interface comprises a personal digital assistant.

8. The system of claim 1 wherein the database includes subjective longitudinal data.

9. The system of claim 8 wherein the subjective longitudinal data comprises one of impressions of the product, impressions of the sales and marketing activities for the product, and impressions of a manufacturer of the product.

10. A method for generating an intelligent promotional recommendation for a product, comprising:
a) receiving a request to generate a promotional recommendation for a target in view of a product;
b) determining attributes of the target in view of the product based on data about the product, data about the target, and longitudinal data related to activity with respect to the product by a population of persons related to the target;
c) classifying the target relative to the population of persons based on the attributes;
d) determining, based on the classification of the target and the longitudinal data related to activity with respect to the product by the population of persons related to the target, a likelihood that each of a plurality of promotional techniques will result in the product being purchased when each of the techniques is used with the target; and
e) selecting the promotional technique having a defined likelihood of resulting in the product being purchased, the selected technique comprising the intelligent promotional recommendation for the product.

11. The method of claim 10 wherein the classifying step comprises one of placing the target in a neighborhood of similar targets within the population of persons and selecting a neural network equation incorporating connection weights modeling a relationship between the target and the product.

12. The method of claim 11 wherein the product comprises a pharmaceutical product, and the target comprises one of a physician, a group of physicians, a managed care provider, and a benefits provider.

13. The method of claim 10 wherein the product comprises a pharmaceutical product, and the target comprises one of a physician, a group of physicians, a managed care provider, and a benefits provider.

14. The method of claim 13 wherein the longitudinal data comprises one of longitudinal patient data and electronic medical record data.

15. The method of claim 10 wherein the longitudinal data related to activity with respect to the product includes longitudinal data related to activity by persons who purchase the product.

16. The method of claim 10 wherein step e) comprises selecting each of the promotional techniques having defined likelihood of resulting in the product being purchased above a defined number, the selected promotional techniques comprising the intelligent promotional recommendation for the product.

17. The method of claim 10 wherein the longitudinal data related to the population of persons comprises subjective longitudinal data.

18. The method of claim 17 wherein the subjective longitudinal data comprises one of impressions of the product, impressions of sales activities for the product, impressions of marketing activities for the product, and impressions of a manufacturer of the product.

19. The method of claim 10 further comprising generating reports based on results from one of steps b), c), d), and e).

20. A method for updating an intelligent promotional recommendation system having a recommendation processing element, comprising:
a) generating a first set of promotional recommendations for a target in view of a pharmaceutical product based on longitudinal data related to activity by the target with respect to the pharmaceutical product;
b) compiling additional longitudinal data related to activity by the target with respect to the pharmaceutical product that is created after the first set of recommendations are implemented; and
c) re-training the processing element to incorporate the additional longitudinal data.
